(19) United States
(12) Patent Application Publication
(10) Pub. No.: US 2015/0305254 A1
(43) Pub. Date: Oct. 29, 2015

(54) METHODS AND DEVICES FOR REDUCTION OF PLANT INFECTIONS

(71) Applicant: University of Florida Research Foundation, Gainesville, FL (US)

(72) Inventors: Reza J. Ehsani, Lakeland, FL (US); Jose L. Reyes De Corcuera, Auburndale, FL (US); Lav R. Khot, Winter Haven, FL (US); Stefani N. Leavitt, Gainesville, FL (US); Cininta A. Pertiwi, Gainesville, FL (US); Ahmed Al-Jumali, Winter Haven, FL (US)

(21) Appl. No.: 14/699,156

(22) Filed: Apr. 29, 2015

Related U.S. Application Data
(60) Provisional application No. 61/985,638, filed on Apr. 29, 2014.

(51) Int. Cl. A01G 7/06; A01G 1/00

(52) U.S. Cl. CPC A01G 7/06; A01G 1/001

(57) ABSTRACT

Embodiments of the present disclosure provide for methods and devices for reducing diseases and infestation in plants. In one embodiment, a system comprises a mobile housing that defines a region that is at least partially enclosed. The mobile housing is configured to be positioned so that a plant is disposed at least partially within the enclosed region. The system further comprises a heating unit that provides heat to the enclosed region. The system further comprises a temperature control unit that controls a temperature within the enclosed region.

### CROSS-REFERENCE TO RELATED APPLICATIONS

This application claims priority to U.S. Provisional Patent Application No. 61/985,638 entitled “METHODS AND DEVICES FOR REDUCTION OF PLANT INFECTIONS,” filed on Apr. 29, 2014, which is incorporated herein by reference in its entirety.

### BACKGROUND

Diseases and infestations of fruit, berry and nut trees can cause severe economic loss to farmers and can adversely impact produce prices, hence, affecting the entire economy. For example, bacterially infected plants, such as the Huanglongbing (HLB)-infected citrus trees, have resulted in economic loss to growers due to reduced crop acreage, yields, and fruit quality. Ultimately, consumers can have to pay more for fresh market fruits and juice.

### BRIEF DESCRIPTION OF THE DRAWING

Further aspects of the present disclosure will be more readily appreciated upon review of the detailed description of its various embodiments, described below, when taken in conjunction with the accompanying drawings.

FIGS. 1-2 are drawings of an example of a plant treatment system according to various embodiments of the present disclosure.

FIGS. 3A and 3B are photos showing examples of the plant treatment system of FIGS. 1 and 2 according to various embodiments of the present disclosure.

FIGS. 4-5 are drawings of another example of a plant treatment system according to various embodiments of the present disclosure.

FIGS. 6-9 are drawings of another example of a plant treatment system according to various embodiments of the present disclosure.

FIGS. 10 and 11 are drawings of examples of treatment procedures using the plant treatment system according to various embodiments of the present disclosure.

FIGS. 12A and 12B show photos of plants treated by the plants treatment system of FIGS. 1-11.

### DETAILED DESCRIPTION

The present disclosure describes various embodiments for methods and devices for reducing diseases and infestations in plants. In one embodiment, a plant treatment system can comprise a mobile housing defining a plant canopy region that is at least partially enclosed. The mobile housing can be configured to be positioned so that a plant is disposed at least partially within the plant canopy region. The mobile housing can comprise a temperature control unit configured to maintain a predetermined temperature in the plant canopy region. Exposing the plant to the temperature can prevent and/or reduce disease and/or infestation growth in the plant.

In another embodiment, a plant treatment system can comprise a steam generator connected to and in communication with a permeable pipe disposed at a base of multiple plants. The steam generator can generate steam at a predetermined temperature and provide the steam via the pipe to the infected trees. The pipe can be configured to withstand a temperature of the steam. In one embodiment, the steam can pass through a permeable portion of the pipe to an environment surrounding the plants, exposing the plants to a temperature sufficient to reduce and/or prevent rate of disease and/or infestation propagation in the plant. In another embodiment, the pipe can be configured to release the steam through nozzles at a predetermined rate such that the environment surrounding the plants is exposed to a temperature at the temperature of the steam. Exposing the plants to certain temperatures can facilitate reduction in the rate of disease and/or infestation propagation as well as the prevention of future disease in the plants.

In yet another embodiment, a plant treatment system can comprise a heat source coupled to a mobile housing defining a plant canopy region that at least partially encloses one or more plants. The heat source can comprise a water reservoir containing water that can be raised to boiling temperature. In one embodiment, the water can be heated to a boil to generate steam. The steam can be transported with little to no pressure through a channel into the plant canopy region via a steam releaser. The channel can be configured to withstand a temperature of the steam. The steam can slowly fill the plant canopy region thereby raising the temperature of the plant to a temperature sufficient to reduce and/or prevent the rate of disease and/or infestation propagation in the plant.

In one embodiment, the water in the water reservoir can be raised to a predetermined temperature and passed through a nozzle configured to release the heated water in vaporized form at a predetermined pressure. The heated water can flash to steam for a predetermined period of time before returning back to a pure heated water form. The heated water and/or the steam can be of a temperature sufficient to reduce and/or prevent rate of disease and/or infestation propagation in the plant.

In one embodiment, the water reservoir can be configured to hold a horticultural mineral oil (HMO) mix. The HMO mix can be raised to a predetermined temperature and passed through a nozzle configured to release the heated HMO in vaporized form at a predetermined pressure. The heated HMO and/or the steam mix can be of a temperature sufficient to reduce and/or prevent rate of disease propagation in the plant.

In some embodiments, the mobile housing can further comprise a medicinal unit configured to hold medicinal liquid for treating the plant. As should be appreciated, the medicinal liquid can be a natural or synthetic material with antibacterial or antiviral properties, such as, for example, Thyme oil, Ampicillin, Carbenicillin, Penicillin, Cefalexin, Rifampicin and Sulfadimethoxine. The medicinal unit can be coupled to a medicine releaser configured to control the flow, pressure, and/or rate of release of the medicine onto the plant. In one embodiment, the medicinal unit can be communicatively coupled to the steam generator such that the medicine can mix with the steam or heated water before being released into the plant canopy.

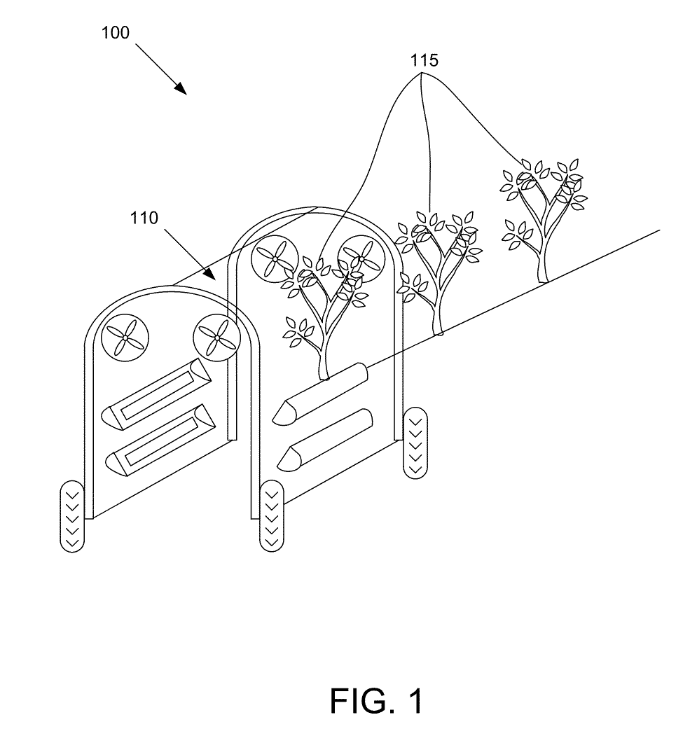

FIG. 1 is a drawing of an example of a plant treatment system 100. Plants that have been thermally treated by plant treatment system 100 can have a relatively longer life span than untreated plants. The plant treatment system 100 can assist in maintaining the quality of fruits, nuts, foliage, and/or any other portion of the plant. For example, the average life span of an Asian citrus psyllid can decrease when exposed to temperatures above a particular value, and the rate of plant disease and/or infestation propagation can decrease at canopy temperatures of about 100.4° F. or higher in greenhouse plants. For instance, the HLB causing bacteria (CLas) population can significantly decrease at temperatures above about 108° F. As such, various embodiments of the plant treatment system 100 can eliminate or reduce the severity of disease within the plants by thermally treating the infected plant. The plant treatment system 100 can be an approach to plant disease management that is less harmful to the environment relative to the use of harmful chemicals. The plant treatment system 100 can be a relatively fast and effective way to treat a large number of plants in a relatively short period of time.

As shown in FIG. 1, the plant treatment system 100 can comprise a mobile housing 110 for treating one or more plants 115. According to some embodiments, plants 115 can be trees, flowers, bushes, crops, herbs, and/or any other plant that can receive thermal treatment according to various embodiments of the present disclosure. The plants 115 can be contaminated with one or more disease and/or infestation propagation. In this regard, the leaves, branches, fruits, berries, nuts, and/or other portions of the plants 115 can be dead or damaged by the disease.

As a non-limiting example, the thermal treatments described herein can facilitate reducing the propagation of, removing, and/or prevent the growth microbial diseases and/or infestations, such as, for example, a viral infection, a bacterial infection, fungal growth, parasite infestation, pest infestation, or any other disease or infestation that can be afflicted on a plant 115. The diseases treated can include foodborne pathogens, such as, for example, Escherichia coli, 0157-H7, Salmonella spp, and Listeria Moncytogenes. For example, thermal treatment can be used to inactivate a ringspot virus in cherry and peach trees. As another illustrative example, thermal treatment can also be used to reduce the number of potato tubers infected by the alfalfa mosaic virus (AMV) and the potato leafroll virus (PLRV). In embodiments used to treat apple plants, bacterial diseases, such as Erwinia amylovora, can be controlled using thermal treatment. In embodiments used to treat sugarcane stalks, thermal treatment can be used to facilitate reducing symptoms of stunting diseases, such as Clavibacter xyli. Furthermore, thermal treatment can be used to reduce the severity of fungal diseases on plants 115. For example, thermal treatment can be used on roses to reduce the severity of the grey mold disease caused by the fungus Botrytis cinerea.

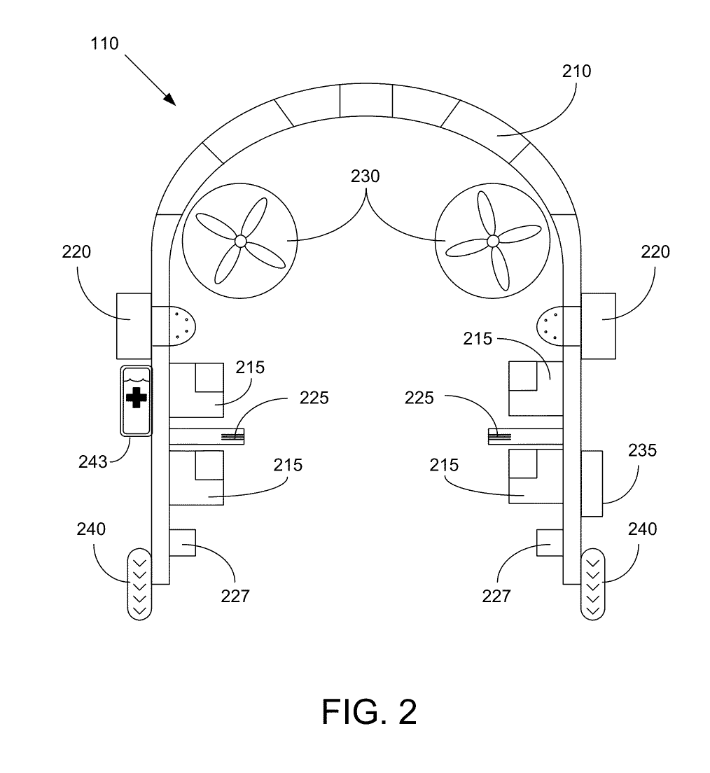

Accordingly, the mobile housing 110 can be configured to treat the plants 115 by exposing each of the plants 115 to a temperature that can facilitate in reducing and preventing the growth or spread of disease in the plants 115. The mobile housing 110 can be used for the in-field treatment of plants 115 for disease management. For example, the mobile housing 110 can be used for the treatment of citrus plants at a citrus farm. The mobile housing 110 can be configured to raise the temperature within the mobile housing 110 to a predetermined temperature, as further described below with respect to FIG. 2. Additionally, the mobile housing 110 can define a volumetric region that is at least partially enclosed. The mobile housing 110 can be configured to be positioned so that at least one of the plants 115 is at least partially within the region that is partially enclosed. That is to say, the mobile housing 110 can be a mobile heating tunnel that can partially enclose a plant 115, while providing thermal treatment to the plant 115. Alternatively, the mobile housing 110 can be embodied as an attachment for over-the-row mechanical harvesting systems.

In one embodiment, the mobile housing 110 can be configured to travel to a plant 115 so that the region within the mobile housing 110 at least partially encloses a portion of the plant 115 as the mobile housing 110 travels to the plant 115. In such an embodiment, once the mobile housing 110 has traveled to the plant 115 and at least partially enclosed the plant 115 to provide thermal treatment to the plant 115, the mobile housing 110 can have treated the entire plant 115. To this end, the plant 115 was exposed to a temperature for a predetermined treatment duration to reduce and/or prevent growth or spread of disease in the plant 115. In another embodiment, the mobile housing 110 can be configured to travel to a plant 115 and partially enclose the entire plant 115 while stopped. In such an embodiment, the mobile housing 110 can expose the plant 115 to a predetermined temperature for the predetermined treatment duration to reduce and/or prevent growth or spread of disease in the plant.

The mobile housing 110 can be constructed of any suitable material that allows for the mobility of the mobile housing 110 while upholding the component parts of the mobile housing 110, as further described below with reference to FIG. 2. For example, the mobile housing 110 can comprise one or more wheels at the base to assist in moving the mobile housing 110. In one embodiment, the mobile housing 110 can be self-propelled such that the mobile housing 110 can automatically accelerate and travel to the plants 115. In another embodiment, the mobile housing 110 can be configured to be moved by another vehicle. For example, the mobile housing 110 can be pulled by a tractor to each one of the plants 115. As another example, the mobile housing 110 can be pushed by a human or machine to provide treatment to the plants 115. In another embodiment, the mobile housing 110 can be a portion of a vehicle that can be driven by a human or a machine and directed to heat the plants 115 at a predetermined temperature for the predetermined treatment duration.

The volumetric region formed by the mobile housing 110 can be heated to a temperature that is sufficient to reduce and/or prevent disease growth in a plant 115. For example, the temperature can be about 113° F. to about 140° F. based on the treatment duration. The treatment duration can be any predetermined period of time that the plant 115 is positioned within the region of the mobile housing 110. As a non-limiting example, the treatment duration can be about five minutes to about 120 minutes. Additionally, the treatment duration can be based on the temperature to which the plant 115 is exposed. As a non-limiting example, at relatively high temperatures, the treatment duration from a few seconds to about ten minutes. However, at relatively low temperatures, the treatment duration can be longer and be about 110 to about 120 minutes because at the relatively low temperatures, the microbes reproduce exponentially without dying. In an embodiment, the temperature can be adjusted based on the treatment duration, and the treatment duration can be adjusted based on the temperature. In other words, the plant 115 can be heated for less time at higher temperatures, and the plant 115 can be heated for more time at lower temperatures. The predetermined temperature and the predetermined treatment duration can also be based at least in part upon the size of the plant 115.

In some embodiments, the mobile housing 110 can generate steam, as further discussed below with reference to FIG. 2. In such embodiments, the use of steam can assist in maintaining the minimal temperature sufficient for effective treatment within a predetermined duration of time within the mobile housing 110. For example, the use of steam can assist in maintaining the temperature at about 122° F. to about 140° F. The use of steam can also reduce the treatment duration. For example, the treatment duration can be from about 30 seconds to about 300 seconds at the predetermined temperature of about 122° F. to about 140° F. in various embodiments. Thus, thermal treatment using steam can result in a faster treatment of the infected plant 115.

According to some embodiments, thermal treatment can be used as an environmentally friendly pesticide treatment as well. For example, insects on the plant 115 can be terminated in response to exposing the plant 115 to the high temperatures. Therefore, thermal treatment can, in some embodiments, be used as pesticide treatment without the use of harmful chemicals.

For certain plants 115, thermal treatment can be used to speed up or instigate blooming in the plants 115. That is to say, exposing the plant 115 to high temperatures can expedite harvest or blooming of the plant. For example, exposing a grape tree to the temperatures described herein for a period of time can pull the tree out of dormancy and instigate the blooming of grapes.

In some embodiments, the plant treatment systems described herein can be transported directly to an orchard or garden in which the infected plant 115 is located. In this way, the plant treatment systems described herein can be transported to any location in which an infected plant 115 is located. The plant treatment systems can at least partially surround one or more infected plants 115 to provide thermal treatment to the one or more infected plants 115. In this way, no part of the infected plant 115 has to be dislodged or dismembered to receive treatment.

FIG. 2 is another drawing of the plant treatment system 100 according to various embodiments. More specifically, FIG. 2 shows a side view of the mobile housing 110. Additionally, as shown in FIG. 2, the plant treatment system 100 can comprise one or more panels 210, heating units 215, steam units 220, humidifying units 225, cooling units 227, circulation units 230, temperature control unit 235, wheels 240, medicinal unit 243, and/or other components. In one embodiment, the panels 210 can facilitate transfer of heat into the region within the mobile housing 110.

For example, the panels 210 can be windows, where sunlight can be absorbed through the panels 210 and aid in heating the region within the mobile housing 110. In another embodiment, the panels 210 can be photovoltaic panels that convert solar energy to electricity to provide power to one or more components of the plant treatment system 100. For example, the panels 210 can generate power from sunlight for the heating units 215, steam units 220, humidifying units 225, cooling units 227, circulation units 230, temperature control unit 235, wheels 240, and/or other components.

The heating unit 215 can be one or more devices configured to provide heated air to the region within the mobile housing 110. For example, the heating unit 215 can comprise an electric radiant heater, infrared heater, or any other suitable type of heater. In operation, the heating unit 215 can heat air and release the heated air into the region within the mobile housing 110. The heating unit 215 can be configured to generate enough heated air so that the entire region within the mobile housing 110 is at a predetermined temperature. As described above, the predetermined temperature for the heat treatment depends upon the size of the plant 115 to be treated, the treatment duration, and/or other factors. In one embodiment, the heating unit 215 can generate enough heated air to treat the plant 115 at the predetermined temperature for the treatment duration. In another embodiment, the heating unit 215 can assist in raising the temperature of the region within the mobile housing 110 along with the other components of the mobile housing 110, as described below.

The steam unit 220 can be one or more devices configured to generate and release steam into the region within the mobile housing 110. To this end, the steam unit 220 can comprise a steam generator and a steam releaser. Particularly, the steam unit 220 can house water to assist the steam generator in generating steam. For example, the steam generator can be configured to heat the water until it boils and becomes steam. The steam generator can then facilitate in directing the steam to the steam releaser.

In one embodiment, the steam can pass through the steam releaser at a predetermined rate into the region of the mobile housing 110 such that the steam is released uniformly throughout the region. In another embodiment, the steam releaser can be configured to release the steam into the region of the mobile housing 110 at a predetermined rate such that steam is released uniformly throughout the region. As a non-limiting example, the steam releaser can be a pump that raises a pressure within the steam unit 220 and then uses the pressure to force the steam out of the steam unit 220 into the region of the mobile housing 110 so that the steam can distribute evenly throughout the region. As another non-limiting example, the steam releaser can be a nozzle that releases steam into all different directions as it is generated. Multiple steam units 220 and/or multiple steam releasers can be placed throughout the mobile housing 110 to uniformly distribute steam into the region of the mobile housing 110. The steam unit 220 and the mobile housing 110 can be configured to maintain a temperature of the steam as it is generated and released throughout the region of the mobile housing 110, using the other components of the mobile housing 110. The released steam can raise the temperature within the region of the mobile housing 110. In one embodiment, the steam unit 220 can generate enough steam to heat the plant 115 to a predetermined temperature for the treatment duration. In another embodiment, the steam unit 220 can assist in raising the temperature of the region within the mobile housing 110 along with the other components of the mobile housing 110. As described above, the use of steam can assist in maintaining the temperature within the mobile housing 110. For example, the use of steam can assist in maintaining the temperature within about 120° F. to about 140° F. The use of steam can also reduce the treatment duration. For example, the treatment duration can be about 30 to about 300 seconds at the temperature of about 120° F. to about 140° F. in various embodiments. Thermal treatment using steam can result in a relatively faster treatment compared to hot air heating of the infected plant 115.

The medicinal unit 243 can be a device that is configured to hold and support medicine or a treatment compound to enhance treatment of the infected plant 115. The medicinal unit 243 can be coupled to a medicine releaser configured to release the medicine into the region of the mobile housing 110. The medicine releaser can also be configured to control the rate, pressure, spread, direction, and/or speed of the flow of the medicine from the medicinal unit 243 into the region.

In one embodiment, the medicinal unit 243 can be communicatively coupled to the steam generator such that the medicine can mix with the steam generated from the steam unit 220 before releasing into the plant canopy. In this way, the medicinal unit 243 can be positioned proximate to the steam unit 220 and/or coupled to the steam unit 220. For example, the medicine from the medicinal unit 243 can pass through a channel into a water reservoir holding the water used to generate steam via a water pump. Then the medicine and the water in the water reservoir can be mixed together before being released into the region to treat the plant 115.

In one embodiment, the medicinal unit 243 can comprise a controller by which an operator of the medicinal 243 can control the amount of medicine that is to be applied to the plant 115. For example, the controller can comprise a user interface by which the operator can enter a measurement, for example, by milliliters or ounces, of the amount of medicine to be applied to the plant 115. In addition, the user interface can be configured to also receive a time entry governing a period of time that the measurement should be released into the region for. As should be appreciated, the controller can be configured to receive any information governing the release of medicine onto the plant 115.

In one embodiment, the medicinal 243 can be configured to hold a horticultural mineral oil (HMO) mix. The HMO mix can be raised to a predetermined temperature and passed through the medicine releaser that is configured to release the heated HMO in vaporized form at a predetermined pressure. The heated HMO and/or the steam mix can be of a temperature sufficient to reduce and/or prevent rate of disease propagation in the plant.

The humidifying unit 225 can be a device that is configured to adjust the humidity of the air within the region of the mobile housing 110. For example, the humidifying unit 225 can comprise an evaporative humidifier that blows air through a moistened filter to humidify the air within the region of the mobile housing 110. Alternatively, the humidifying unit 225 can comprise a vaporizer, an impeller, an ultrasonic humidifier, a wick/evaporative system, and/or any other suitable device for humidifying air. The cooling unit 227 can be a device that is configured to cool the temperature of the air within the region of the mobile housing 110. For example, the cooling unit 227 can be an air conditioning unit, a fan, a thermoelectric cooler, and/or any other suitable device for cooling the plant.

The circulation unit 230 can be a device that circulates the air within the region of the mobile housing 110 such that the predetermined temperature is maintained within the region for the treatment duration. The circulation unit 230 can comprise one or more fans configured to provide airflow within the region of the mobile housing 110. The fans of the circulation unit 230 can generate airflow that results in substantially uniform temperatures distributed evenly throughout the region of the mobile housing 110. For example, the circulation unit 230 can circulate the heated air and steam within the region of the mobile housing 110 such that the temperature is maintained uniformly throughout the region, thereby providing uniform thermal treatment to the plant 115.

The temperature control unit 235 can be a device configured to control and monitor the temperature within the region of the mobile housing 110 such that the temperature is within the predetermined temperature. According to some embodiments, the temperature control unit 235 can allow the operator of the mobile housing 110 to adjust the temperature within the region. For example, the temperature control unit 235 can allow the operator of the mobile housing 110 to adjust the temperature within the region from about 100° F. to about 150° F. In one embodiment, the panels 210, heating units 215, steam units 220, humidifying units 225, cooling units 227, circulation units 230, medicinal unit 243, and the temperature control unit 235 can be integrated such that the temperature control unit 235 controls the temperature within the region of the mobile housing 110. For example, the component units of the mobile housing 110 can communicate with one another to operate in conjunction.

As a non-limiting example, an operator of the mobile housing 110 can program the predetermined temperature into the temperature control unit 235. The temperature control unit 235 can automatically adjust each of the heating units 215, steam units 220, humidifying units 225, cooling units 227, and/or circulation units 230 such that the temperature within the region of the mobile housing 110 is maintained uniformly throughout at a predetermined temperature. Particularly, the temperature control unit 235 can control the temperature at which the heating unit 215 provides and releases heated air. The temperature control unit 235 can also control the steam unit 220. Additionally, the temperature control unit 235 can control the humidity level using the humidifying unit 225. The temperature control unit 235 can also control the speed of one or more fans of the circulation unit 230. Furthermore, the temperature control unit 235 can control how the components work together to maintain predetermined temperature, thereby providing thermal treatment to the plant 115 at the predetermined temperature. In another embodiment, the components can operate in coordination while communicating with one another to maintain predetermined temperature in the region. For example, the heating unit 215 and the steam unit 220 can communicate with one another so that both the heating unit 215 and the steam unit 220 assist in heating the air in the region of the mobile housing 110 to a predetermined temperature. In such an embodiment, the temperature control unit 235 can be used to provide the mobile housing 110 with details of the plant 115 to be treated and a predetermined temperature and treatment duration, such that the component parts can work together and treat the plant 115 accordingly.

The temperature control unit 235 can comprise a user interface to facilitate the operator of the mobile housing 110 to enter details of a plant 115 to be subject to a heat treatment. For example, the operator can enter the height, width, depth, and/or other characteristics of the plant 115 to be treated into the user interface of the temperature control unit 235. According to some embodiments, the depth of the plant 115 can be a diameter of the farthest points of the branches of the plant.

The mobile housing 110 can be configured to automatically adjust in size so that the mobile housing 110 can at least partially enclose the plant 115. For example, if the plant 115 to be treated is bigger than the mobile housing 110 can fit, the mobile housing 110 can automatically adjust one or more dimensions of the mobile housing 110 such that the mobile housing 110 can at least partially enclose the bigger plant 115 successfully. To this end, the mobile housing 110 can comprise adjustable support members that can change one or more dimensions of the mobile housing 110. For example, the mobile housing 110 can comprise one or more telescoping support members that can expand or retract to thereby adjust the size of the region in the mobile housing 110. As another illustrative example, the mobile housing 110 can comprise foldable components to facilitate adjusting the size of the region in the mobile housing. The mobile housing 110 can also rotate as needed to assist in adjusting the size of the mobile housing 110 to fit the plant 115. Alternatively, the dimensions of the mobile housing 110 can be manually adjusted by the operator such that the mobile housing 110 can partially enclose the bigger plant 115 successfully.

According to some embodiments, the temperature control unit 235 can automatically calculate the predetermined temperature and predetermined treatment duration after the operator enters the details of the plant 115. In such an embodiment, the mobile housing 110 can be configured to provide treatment to the plant 115 at the calculated temperature and treatment duration without any further involvement from the operator. Alternatively, the operator of the mobile housing 110 can manually enter the predetermined temperature and treatment duration into the user interface of the temperature control unit 235.

The operator of the mobile housing 110 can be a human or a machine. The operator of the mobile housing 110 can use the mobile housing 110 to provide treatment to a plant 115 by passing through the mobile housing 110. The operator can begin my entering the dimensions of the plant 115 into the temperature control unit 235. The mobile housing 110 can adjust in size, either manually or automatically, to partially enclose the plant 115. In one embodiment, the mobile housing 110 can travel to the plant 115 such that the region of the mobile housing 110 can partially enclose at least a portion of the plant 115 and provide treatment to that portion of the plant 115 as the mobile housing 110 partially encloses around the plant 115. In another embodiment, the mobile housing 110 can travel to the plant 115 and stop at the plant 115 so as to enclose the entire plant 115 within the region of the mobile housing 110. The temperature control unit 235 can determine the temperature and the corresponding treatment duration that can prevent and/or reduce rate of disease growth in the plant 115. The temperature control unit 235 can communicate with the panels 210, heating units 215, steam units 220, humidifying units 225, cooling units 227, circulation units 230, and/or other components to maintain a predetermined temperature within the region of the mobile housing 110. The temperature control unit 235 can also communicate with the panels 210, heating units 215, steam units 220, humidifying units 225, the cooling units 227, circulation units 230, and/or other components to maintain a temperature uniformly throughout the region of the mobile housing 110 for the treatment duration.

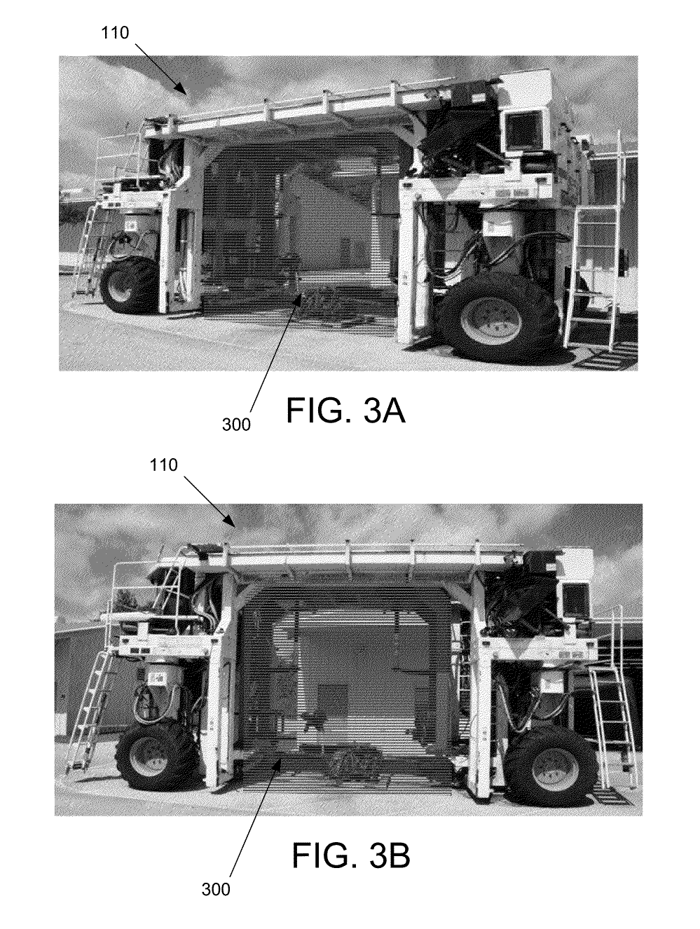

FIGS. 3A and 3B are photos showing examples of the plant treatment system 100 of FIGS. 1 and 2. More specifically, FIGS. 3A and 3B show different views of an embodiment of the mobile housing 110, wherein the mobile housing 110 is self-propelled. The mobile housing 110 can define the region 300, which is represented in FIGS. 3A-3B by a shaded box. As described above with reference to FIGS. 1 and 2, the mobile housing 110 can be configured to partially enclose a plant 115 within the region 300. The mobile housing 110 can be adjustable so that at least one dimension of the region 300 is adjustable. For example, if the plant 115 to be treated is taller than the region 300, the mobile housing 110 can be adjusted in height such that the height of the region 300 is taller than the height of the plant 115.

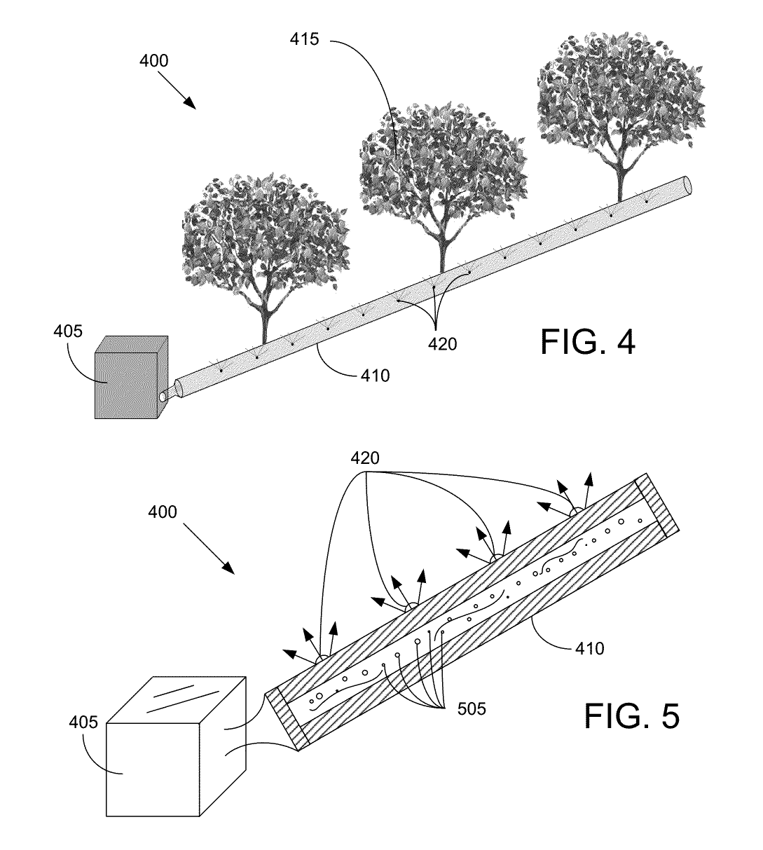

FIG. 4 is a drawing of another example of a plant treatment system 400 according to various embodiments of the present disclosure. Particularly, the plant treatment system 400 can comprise a steam generator 405, a pipe 410, a plurality of plants 115, and/or other components. The steam generator 405 can comprise a water reservoir containing water that is boiled and produces steam at the predetermined temperature. The pipe 410 can be any shape or size suitable for storing and releasing steam into the environment. The pipe 410 can be constructed of any permeable material configured to withstand heat from the steam that can be provided to the pipe 410 and maintain the temperature of the steam stored and released into the environment. For example, the pipe 410 can be a permeable sock tube. In such a case, the pipe 410 can be made of a material that allows liquids and/or gasses to pass through it. According to some embodiments, the pipe 410 can be built in a cylindrical shape, and the pipe 410 can be disposed at the base of multiple plants 115 such that the plants 115 can be treated simultaneously.

The pipe 410 can comprise nozzles 420, and the steam can pass from the pipe 410 through the nozzles 420 into the atmosphere surrounding the plants 115. Particularly, the nozzles 420 can open and allow the steam to pass through the nozzles 420, and then the nozzles 420 can close and restrict the steam from passing through. Alternatively, the nozzles 420 can be configured to release the steam generated by the steam generator 405 at a predetermined rate such that the environment surrounding the plant 115 is exposed to the temperature of the steam.

The pipe 410 can maintain the temperature of the steam before the steam is released into the atmosphere surrounding the plant 115. For example, the pipe 410 can be configured to store the steam so that the steam passes through the nozzles 420 at the same temperature at which the steam was generated. In this regard, the pipe 410 can be configured to maintain the temperature of the steam within the pipe 410. Alternatively, the temperature to which the plant 115 is exposed can be different than the temperature of the steam when it was generated by the steam generator 405. For example, the temperature of the steam can slightly decrease as it is released from the steam generator 405 and/or as it is passes into the pipe 410. In this case, the trees can be exposed to a temperature that is relatively lower than the temperature of the steam when the steam was generated.

FIG. 5 is another drawing of an example of the plant treatment system 400 of FIG. 4 according to various embodiments. Particularly, the plant treatment system 400 can comprise the steam generator 405, the pipe 410, and/or other components. The steam generator 405 generates steam 505 having a predetermined temperature that can be sufficient to reduce and/or prevent the rate of disease growth within a plant 115 to be treated. The pipe 410 can comprise nozzles 420. In one embodiment, the nozzle 420 can be configured to release the steam 505 a predetermined number of times. Releasing the steam 505 the predetermined number of times can result in the plant 115 being heated to a predetermined temperature for the treatment duration. Releasing the steam 505 the predetermined number of times can also reduce and/or prevent growth of disease and/or infestation in the plant 115. In another embodiment, the nozzle 420 can be configured to release the steam 505 one time for a particular duration, and such a release can be sufficient to reduce and/or prevent disease growth in the plant 115. In such an embodiment, the predetermined temperature can be relatively high and the corresponding treatment duration can be a relatively short length of time.

To begin treatment of a plant 115, the steam generator 405 can generate the steam 505 having a predetermined temperature. Once the steam 505 has been generated, the steam 505 can then travel through the pipe 410. The pipe 410 can store the steam 505 while maintaining and/or heating the temperature of the steam 505, following which, the steam 505 can pass through the nozzles 420 into the environment surrounding the plants 115. Alternatively, the steam 505 can be released at a predetermined rate by the nozzles 420. In such an embodiment, the nozzles 420 can be configured to release the steam 505 at a predetermined rate such that the environment surrounding the plant 115 is exposed to the temperature of the steam 505. The nozzles 420 can release the steam 505 multiple times until the plant 115 has been heated to a temperature at the temperature sufficient to reduce and/or prevent disease and/or infestation of the plants 115. The nozzles 420 can be configured to treat the same plant 115 or for treating different plants 115. As such, multiple nozzles 420 can be configured to release the steam a predetermined number of times based on the condition and the size of the plant 115 that is being treated by the corresponding nozzles 420. For example, if two of the nozzles 420 are treating a minor disease in a first plant 115 and two of the nozzles 420 are treating a major disease in a first plant 115, the two nozzles 420 treating the minor disease will release the steam in a different manner than the two nozzles 420 treating the major disease.

Similar to the plant treatment system 100, the plant treatment system 400 can comprise additional components, such as panels 210, heating units 215, steam units 220, humidifying units 225, cooling units 227, circulation units 230, and temperature control unit 235 described with reference to FIG. 2. The temperature control unit 235 of the plant treatment system 400 can comprise a user interface that allows an operator to enter details for the plant 115 being treated. The user interface of the temperature control unit 235 can also allow the operator to enter steam release timings for each of the nozzles 420, wherein the steam release timings are time intervals that steam 505 should be released through each of the nozzles 420. The steam release timings can depend on the size of the plant 115, the disease condition of the plant 115, and the micro-climatic condition outside. The micro-climatic condition outside can depend on the humidity level, outside temperature, and wind level, and the general environment surrounding the plant 115. Therefore, the temperature at which the steam is generated by the steam generator 405 and the steam release timings can be based at least in part upon the micro-climatic condition outside.

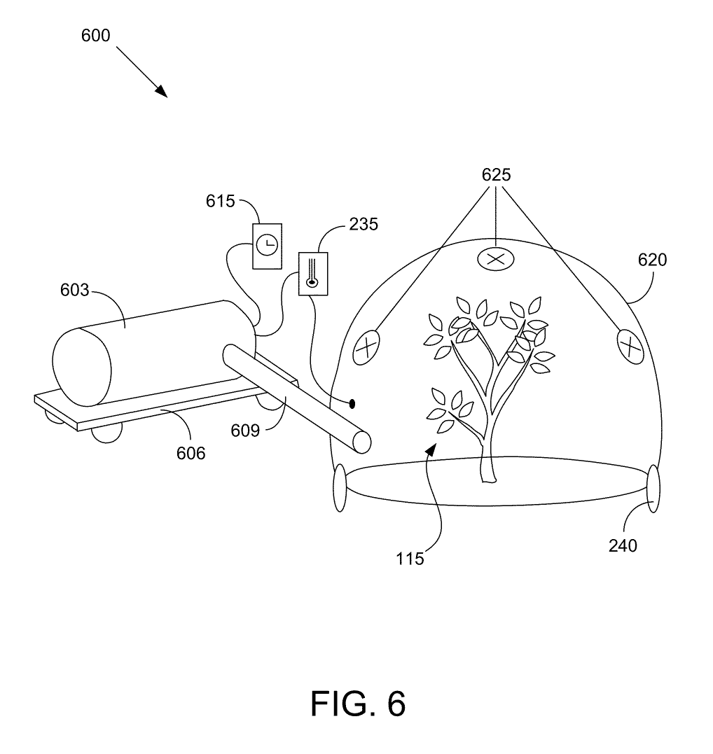

FIG. 6 is a drawing of another example of a plant treatment system 600 according to various embodiments of the present disclosure. Specifically, the plant treatment system 600 can comprise a heat source 603, base 606, a channel 609, temperature control unit 235, timing control unit 615, mobile housing 620, circulation units 230, and/or other components. In some embodiments, the plant treatment system 600 can further comprise the panels 210, heating units 215, steam units 220, humidifying units 225, cooling units 227, circulation units 230, and/or medicinal unit 243, as described above with reference to FIG. 2. The plant treatment system 600 can be configured to treat the plant 115 by at least partially enclosing a region surrounding a canopy around the plant 115 using the mobile housing 620.

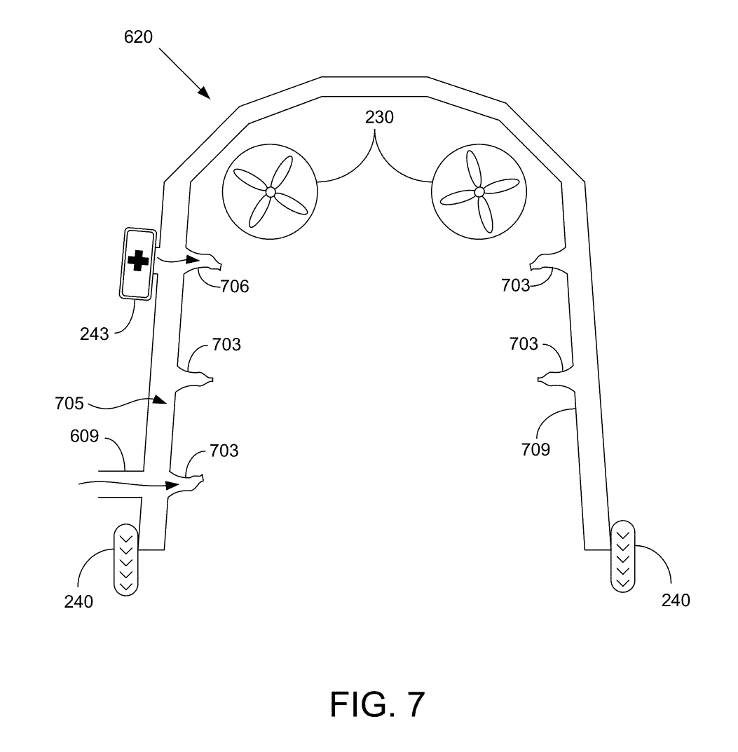

In some embodiments, heating of the canopy of the plant 115 can be performed without the use of hot water or steam. In such embodiments, the hot dry air or other hot gas can be injected into the canopy of the plant 115 using the mobile housing 110 described in FIGS. 1 and 2. The treatment duration for thermal treatment using hot air or other hot gas can be about 5 minutes to about 10 minutes at a temperature of about 120° F. to about 150° F. In some embodiments, wet heat is generated using water in the form of steam and/or vaporized heated water, and is thereafter injected into the canopy of the plant 115. In such embodiments, the wet heat, which, for example, can be injected into the canopy of the plant using the mobile housing 620 described in FIGS. 6 and 7, can have a treatment duration of about 15 seconds to about 30 seconds at a temperature of about 120° F. to about 150° F.

According to some embodiments, the mobile housing 620 can be structured similar to the mobile housing 110 described with reference to FIG. 2. In another embodiment, the mobile housing 620 can be embodied as a tent that an operator can manually assemble around one or more infected plants 115 to provide treatment. The tent can be adjustable to the size of the plant 115 being treated. For example, the tent may comprise foldable regions that can be zipped together or otherwise securely attached to one another such that the size of the region within the tent is adjustable. The tent can also be configured to withstand the temperature required to reduce propagation of disease within the plant 115.

In some embodiments, the heat source 603 can be one or more devices configured to provide heated air, water, and/or steam to the region within the mobile housing 620. In some embodiments, the heat source 603 can be structured and function similar to the heating unit 215 described with reference to FIG. 2. In some embodiments, the heat source 603 can be structured and function similar to the steam unit 220 described with reference to FIG. 2.

The heat source 603 can comprise a water reservoir configured to hold water that can be passed into the region of the mobile housing 620 as steam or vaporized water. In this regard, the water reservoir can be coupled to an electric heater or any other suitable type of heater configured to raise the temperature of the water. In one embodiment, the water can be heated to a boiling temperature such that steam is generated in the heat source 603. In another embodiment, the water can be heated to a predetermined temperature and then transported through the channel 609 into the region within the mobile housing 620 via a nozzle.

In one embodiment, the plant treatment system 600 can comprise the base 606 configured to support the heat source 603. The base 606 can also be configured to transport the heat source 603 to the plant 115 via wheels at the bottom of the base 606. The bases 606 can be configured to move from one infected plant 115 to another similar to the ways that the mobile housing 110 is configured to move, as described with reference to FIG. 2. In one embodiment, the plant treatment system 600 can comprise the channel 609 configured to facilitate transmitting the heated water, steam, and/or air from the heat source 603 to the region within the mobile housing 620.

The temperature control unit 235 can be configured to function similar to the temperature control unit 235 described with reference to FIG. 2. According to some embodiments, the temperature control unit 235 can allow the operator of the mobile housing 110 to adjust and/or control the temperature within the region. For example, the temperature control unit 235 can allow the operator of the mobile housing 110 to adjust the temperature within the region from about 100° F. to about 150° F. Additionally, the temperature control unit 235 can control the steam or vaporized water generated from the heat source 603 such that a temperature within a region of the mobile housing 620 is maintained is about 122° F. to about 140° F. for a predetermined treatment duration. The predetermined temperature can be measured to be the average temperature around the canopy near the surface of the plant 115 being treated by the plant treatment system 600.

The temperature control unit 235 can also control the speed of one or more fans of the circulation unit 230. The circulation unit 230 can be configured to maintain a uniform temperature within the entirety of the region that is at least partially enclosed by the mobile housing 620. Furthermore, the temperature control unit 235 can control how the components work together to maintain the temperature at a predetermined temperature, thereby providing thermal treatment to the plant 115 at the predetermined temperature for the predetermined temperature duration. An operator of the plant treatment system 600 can be configured to monitor the temperature of the region within the mobile housing 620 using the temperature control unit 235.

The time control unit 615 can be configured to facilitate controlling a time of treatment, or the treatment duration, of thermal treatment of the plant 115. That is to say, the time control unit 615 can be configured to allow the operator of the plant treatment system 600 to set the treatment duration for the plant 115 being treated. For example, the time control unit 615 can allow the operator to adjust or manually enter a time for treating the plant 115 at the temperature entered via the temperature control unit 235. In this regard, the operator can enter the time into the time control unit 615, and the plant treatment system 600 can be configured to automatically generate and apply steam and/or heated water at the specified temperature for the specified time. Specifically, the time control unit 615 can be configured to start the time only when the temperature of the canopy of the plant 115 in the region of the mobile housing 620 has reached a temperature within the predetermined temperature. For example, a predetermined treatment duration can be about 3 and about 300 seconds. Specifically, the predetermined treatment duration can be about 30 seconds for a temperature of about 120° F. and about 140° F.

In one embodiment, steam can be generated in the heat source 603 by raising the temperature of the water in the water reservoir to a boil. In one embodiment, the steam can be transmitted through the channel 609, using relatively low pressure, if any, through a steam releaser connected to an end of the channel 609 positioned within or proximate to the region of the mobile housing 620. The steam releaser can be configured to allow the steam to pass from the channel 609 to the canopy of the plant 115 that is enclosed by the mobile housing 620. The steam releaser can also be configured to control the spread, direction, pressure, and/pr rate of the release of the steam from the channel 609 into the region.

In one embodiment, the steam can pass directly from the heat source 603 into the region within the mobile housing 620 via a steam releaser without the use of a channel 609. In such an embodiment, the steam can be passed through the steam releaser into the canopy surrounding the plant 115 to be treated. The steam can be a temperature at the predetermined temperature which was set, for example, using the temperature control unit 235. The steam can be exposed to the plant for a predetermined temperature duration. The temperature and treatment duration can be sufficient to reduce and/or prevent rate of growth of the disease in the plant.

In one embodiment, the water in the water reservoir of the heat source 603 can be heated to a vaporization temperature that can be predetermined according the quantity of water within the water reservoir. The water can be heated at a relatively high predetermined pressure sufficient to vaporize the water when passing through a nozzle configured to release the heated water in vaporized form. The predetermined pressure can be, for example, from about 100 PSI to 4,000 PSI. The heated water released that can flash to steam can be as high as 250° F. The heated water can be transmitted from the heat source 603 into the region within the mobile housing 620 via the channel 609, for example, at the predetermined pressure. The heated and pressurized water can then pass through the nozzle, which can further control the pressure, direction, spread, rate, and/or flow of the water from the heat source 603 into the region within the mobile housing 620.

The heated water, at the predetermined temperature and pressure, once released from the nozzle into the region, can be embodied as a steam for a short period of time. For example, the heated water can be released as steam for less than about five seconds. After that period of time, the steam will return to a pure water form within the predetermined temperature or slightly lower than the predetermined temperature. This embodiment that exposes the plant 115 to wet vaporized water at a high temperature can result in treatment of the plant 115 while minimizing damage to the tree.

According to some embodiments, the use of steam can allow the temperature inside the region of the mobile housing 620 to rise relatively faster, for example, in a matter of less than about five seconds. In this way, the temperature of the plant 115 to be treated can rise in less than about ten seconds. Therefore, steam can be used to treat numerous trees under a mobile housing 620 within a certain period.

FIG. 7 is another drawing of the plant treatment system 600 according to various embodiments of the present disclosure. More specifically, FIG. 7 shows a side view of one embodiment of the mobile housing 620. As shown in FIG. 7, the plant treatment system 600 can comprise the channel 609, the mobile housing 620, and/or other components. The mobile housing 620 can comprise the steam nozzle 703, medicinal unit 243, air circulation units 230, wheels 240, interior volumetric region 705, inside surface 709, and/or other components. In some embodiments, the mobile housing 620 can further comprise the panels 210, heating units 215, steam units 220, humidifying units 225, cooling units 227, circulation units 230, temperature control unit 235, and/or timing control unit 615.

In one embodiment, the channel 609 can be used to direct transmission of the steam and/or heated water from the heat source 603 to the region within the mobile housing 620. The steam and/or heated water can pass through the steam nozzle 703 before being released into the region within the mobile housing 620. In this regard, the steam nozzle 703 can be positioned at a location on or proximate to the inside surface 709 of the mobile housing 620. The steam nozzle 703 can also be coupled to one end of the channel 609.

As shown in FIG. 7, the steam nozzle 703 can be disposed at various points on the inside surface 709 of the mobile housing 620. The steam nozzle 703 can be configured to control the pressure, direction, spread, rate, and flow of the water and/or steam from the heat source 603 or channel 609 into the region within the mobile housing 620. In one embodiment, the steam and/or heated water can pass from the channel 609 into an interior volumetric region 705 of the mobile housing 620. In this way, the steam and/or heated water can be released into the region within the mobile housing 620 by way of the plurality of steam nozzles 703 disposed throughout the inside surface 709 of the mobile housing 620.

In one embodiment, water can be heated to the predetermined temperature and released through the channel 609 into the interior volumetric region 705 of the mobile housing 620. The heated water can be continuously released from the heat source 603 through the channel 609 for the predetermined temperature duration. The heated water can then be released through the steam nozzle 703 into the region within the mobile housing 620 at a predetermined pressure such that the heated water flashes to steam for a period of time before returning to a pure water state. The heated water and/or steam surrounding the canopy of the plant 115 can raise the temperature of the infected plant 115 being treated by the plant treatment system 600, thereby reducing the symptoms of the disease and/or preventing spread of the disease within the plant 115. As can be appreciated, the heated water can be released directly from the heat source 603 through the steam nozzle 703 into the region within the mobile housing 620.

In another embodiment, the heat source 603 can be configured to release steam into the channel 609, for example, by way of boiling water in a water reservoir within the heat source 603 for a predetermined time period. In this way, the steam can be released from the heat source 603 through the channel 609 into the interior volumetric region 705 of the mobile housing 620, through the steam nozzles 703, and into the region within the mobile housing 620.

According to some embodiments, the mobile housing 620 can further comprise the medicinal unit 243. The medicinal unit 243 can be a device that is configured to hold and support medicine or a treatment compound to enhance treatment of the infected plant 115. The medicinal unit 243 can be coupled to a medicine releaser 706 configured to release the medicine into the region of the mobile housing 110 and thereby onto the plant 115 being treated. The medicine releaser 706 can also be configured to control the rate, pressure, spread, direction, and/or speed of the flow of the medicine from the medicinal unit 243 into the region.

In one embodiment, the medicinal unit 243 can be communicatively coupled to the heat source 603 such that the medicine can mix with the steam and/or heated water generated by the heat source 603 before releasing into the plant canopy, as described below with reference to FIG. 9. In this embodiment, the medicinal unit 243 can be positioned proximate to the heat source 603 and/or channel 609.

In another embodiment, the medicinal unit 243 can be communicatively coupled to the heat source 603. For example, the medicine from the medicinal unit 243 can pass through a channel into a water reservoir holding the water used to generate steam using a water pump. The medicine and the water in the water reservoir can be mixed together before released into the region to treat the plant 115.

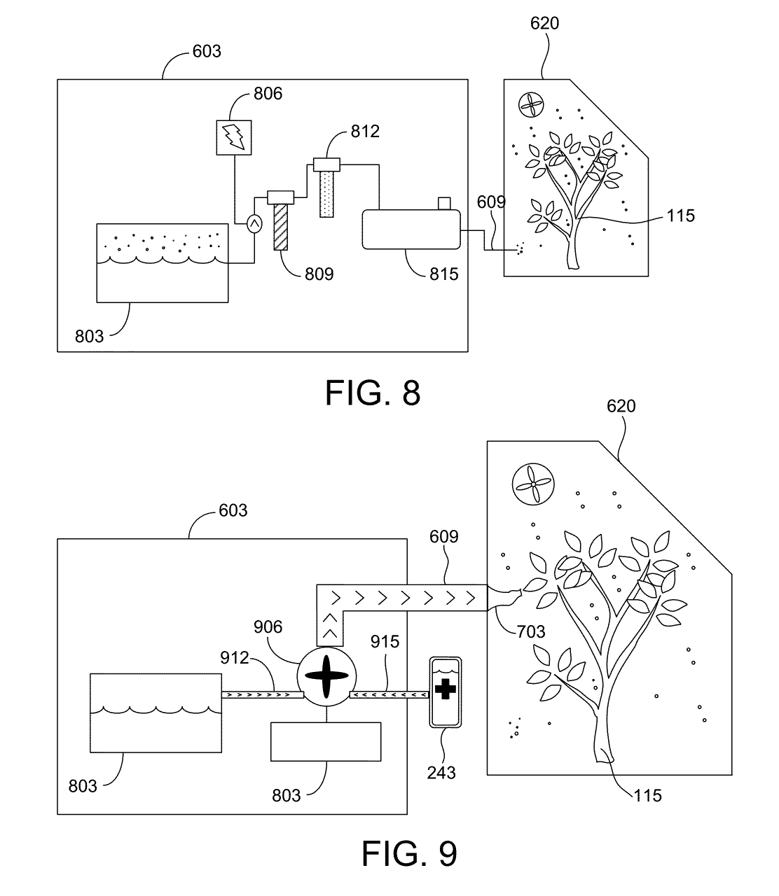

FIG. 8 shows a drawing of the plant treat system 600 according to various embodiments. As shown in FIG. 8, the plant treatment system 600 comprises the heat source 603, channel 609, mobile housing 620, and/or other components to treat the plant 115. In particular, the heat source 603 can be configured to generate steam and/or heated water to be released through the channel 609 into the region within the mobile housing 620. In the embodiment shown in FIG. 8, the heat source 603 can comprise a water reservoir 803, gas generator 806, charcoal filter 809, water softener 812, diesel boiler 815, and/or other components to facilitate heating the water.

In some embodiments, the water reservoir 803 can be configured to hold water that is heated using the gas generator 806 and/or the diesel boiler 815. The gas generator 806 can be configured to generate gas to facilitate heating of the water or guiding the water through the charcoal filter 809, water softener 812, and/or diesel boiler 815. The gas generator 806 can be electrically coupled to an engine or motor.

In some embodiments, the water can be drawn through the charcoal filter 809. The charcoal filter 809 can be configured to eliminate impurities in the water and facilitate purifying the water used to treat the plant 115. In some embodiments, the water can then be drawn to the water softener 812. The water softener 812 can be configured to convert hard water into soft water by removing calcium and magnesium, for example, from the water. The water softener 812 can comprise a resin bed, for example, configured to exchange hard ions in the water for soft ions.

In some embodiments, the water can then be drawn into the diesel boiler 815. The diesel boiler 815 can be embodied as a heat source to facilitate heating the water to boiling temperatures, for example. The diesel boiler 815 can be configured to communicate with the temperature control unit 235 to control the temperature of the water being heated. In some embodiments, the diesel boiler 815 can be configured to generate high pressure steam and/or high pressure vaporized water. The diesel boiler 815 can comprise fuel which can be burned to release energy that can be stored in the form of steam with high temperature and pressure. The fuel can be burnt in a combustion chamber inside the boiler, for example.

FIG. 9 shows a drawing of a plant treatment system 600 according to various embodiments of the present disclosure. In particular, FIG. 9 shows an embodiment of the plant treatment system 600 whereby medicine is mixed with the heated water and/or steam to provide enhanced treatment to the plant 115. As shown in FIG. 9, the plant treatment system comprises a heat source 603, channel 609, medicinal unit 243, mobile housing 620, and/or other components.

According to some embodiments the heat source 603 can comprise the water reservoir 803, power source 903, water pump 906, water inlet 912, medicine inlet 915. The power source 903, for example, can be embodied as an engine or a motor that facilitates powering the water pump 906. The water pump 906 can be configured to draw the water from the water reservoir 803 via the water inlet 912 and draw medicine from the medicinal unit 243 via the medicine inlet 915. In some embodiments, the water pump 906 can be configured to mix the medicine and the heated water together before transporting the mix to the channel 609.

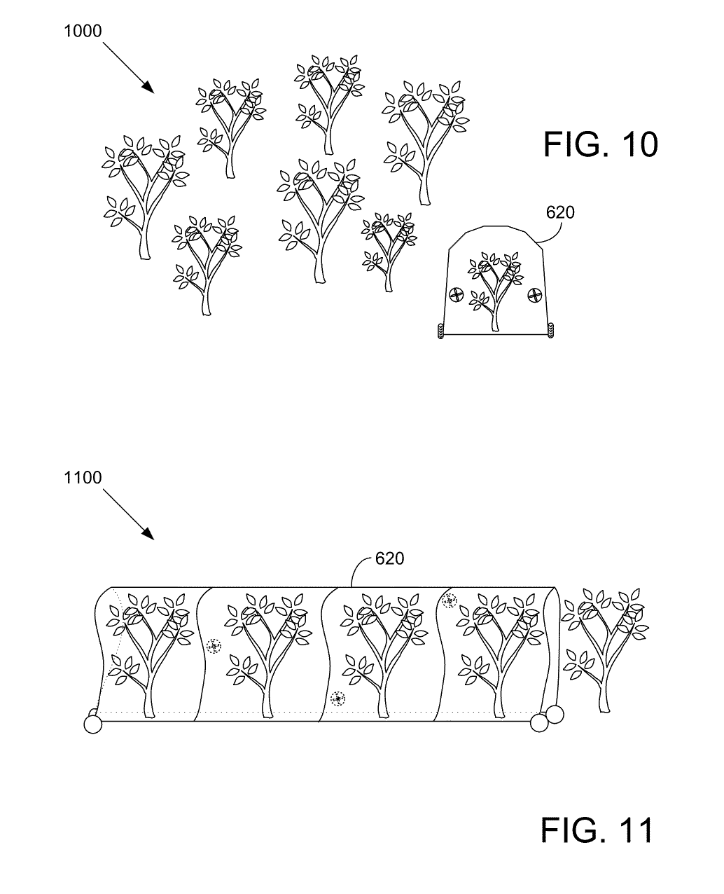

FIG. 10 is a drawing of an example treatment set up type using the plant treatment system 600 according to various embodiments of the present disclosure. In particular, FIG. 10 shows an individual plant treatment system 1000 that uses a mobile housing 620 that is configured to treat one plant 115 at a time. Such an individual plant treatment system 1000 can be useful for treatment where only one plant 115 in an orchard or garden is infected. In this way, the mobile housing 620 can be configured to fully or partially enclose one plant and then move to treat the next plant 115. In one embodiment, an operator of the individual plant treatment system 1000 can manually cover and uncover each plant 115 upon initiating or terminating treatment.

The plant treatment system 600 and/or the mobile housing 620 can be constructed of any suitable material that allows for the mobility of the mobile housing 620 while upholding the component parts of the mobile housing 620. For example, the plant treatment system 600 and can comprise one or more wheels 240 at the base of the mobile housing 620 and the heat source 603 to assist in moving the plant treatment system 600 from plant 115 to plant 115. In one embodiment, the plant treatment system 600 can be self-propelled such that the plant treatment system 600 can automatically accelerate and travel to the plants 115. In another embodiment, the plant treatment system 600 can be configured to be moved by another vehicle. For example, the plant treatment system 600 can be pulled by a tractor to each one of the plants 115. As another example, the plant treatment system 600 can be pushed and/or pulled by a human or machine to provide treatment to the plants 115. In another embodiment, the plant treatment system 600 can be a portion of a vehicle that can be driven by a human or a machine and directed to heat the plants 115 at a temperature at the predetermined temperature for the predetermined treatment duration.

FIG. 11 is a drawing of another example treatment set up type using the plant treatment system 600 according to various embodiments of the present disclosure. In particular, FIG. 11 shows a batch plant treatment system 1100 that uses a mobile housing 620 that is configured to provide thermal treatment to a plurality of plants 115 at a time. In this way, the plant treatment system 600, and specifically the mobile housing 620, are structured to fully or partially enclose a plurality of plants 115 at once. As shown in FIG. 11, the batch plant treatment system 1100 can be embodied as a heating tunnel which at least partially encloses multiple plants 115 in a line. The batch plant treatment system 1100 can move slowly over the line of plants 115 as the treatment is applied. The batch plant treatment system 1100 can be configured to move similar to the individual plant treatment system 1000 described with reference to FIG. 10.

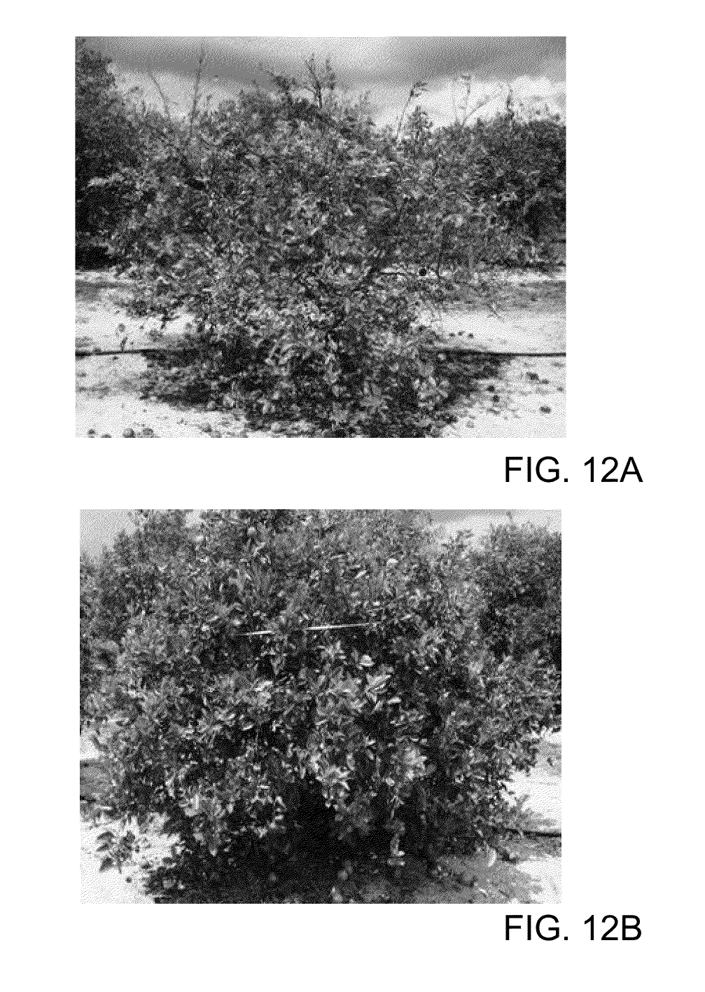

FIGS. 12A and 12B show photos of citrus plants 115 treated by the plant treatment system 100, 400, and 600 of FIGS. 1, 4, and 6, respectively. Particularly, the plant 115 in FIG. 6A shows a photo of a symptomatic treated citrus plant, and the plant 115 in FIG. 6B shows a photo of an untreated citrus plant after 9-months of thermal treatment using the plant treatment system 400 described herein. FIGS. 12A and 12B can show that the disease was effectively mitigated from the most prominent symptomatic citrus plants. Treated plants 115 can look healthier than the surrounding, untreated plants 115 that can show severe symptoms. Treated plants 115 can also have a yield close to that of healthy plants with an equivalent mean soluble solids content of 12.0° Brix.

### Example

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

Brief Introduction

Thermal treatment can be done at a higher temperature in less time, while the second theory suggests that a lower temperature with longer time is sufficient. Supplementary heat can be used to raise the temperature applied to the tree. The reasoning behind this is that if only solar heat is used to heat the tree, the temperature may not be high enough at certain time during the day and also is not consistent due to weather variability. Thus, having supplementary heat will help ensure a more consistent treatment. Having supplementary heat also allows for more control over the applied temperature and heating duration. This embodiments disclosed herein to provide the core points of the treatment and can be used as reference in developing innovative systems to accommodate large-scale treatments for implementation in commercial citrus groves.

The major factors to consider in heat treatment are heating time and temperature. Two values, the “D-value” and “z-value”, are terms associated with determining time and temperature required for microbial kill. The D-value represents the time required to reduce the microbial population by about 90% while the “z-value” is defined as the increase in temperature that produces a ten-fold increase in the rate of microbial kill. For example, a bacterium with a D-value of about 140 minutes at about 113° F. and a z-value of about 50° F. would have a D-value of about 14 minutes at about 131° F. In other words, at about 113° F., it would take about 140 min to kill about 90% of the bacteria population while it would take about 14 min to produce the same microbial kill at about 131° F.

For HLB, since the bacteria causing it (Candidatus liberibacter asiaticus) cannot be cultured, there are several drawbacks in determining the correct time and temperature. These drawbacks include not being able to accurately determine D-values for any particular treatment, hence the z-values cannot be determined. Because of this, from the perspective of microbial kill, it appears nearly impossible to determine the right treatment. However, a pseudo-D-value can be defined, also known as the “H-value”, so this will help us define the right time-temperature regimes. The H-value is defined as the time required for a treatment at a particular temperature that will result in sufficient microbial reduction to result in a tree with sustained productivity, or in other words, a tree that produces fruit at a yield and quality similar to a healthy tree. Therefore, if the temperature of the canopy were to be instantaneously raised to about 122° F., it would take between about 40 min and about 268 min (about 2.3 hours) to significantly reduce bacterial loads and keep trees in production. Suppose to the trees were to be treated at a different temperature, such as, for example, about 131° F. or about 140° F. Having the option of providing consistent supplemental heat as a means of controlling temperature can facilitate determining these values and efficient treatment.

Modeling Heating Time and Temperature Based on Tree Diameter

A size of the tree can affect the heating time and temperature combinations for thermal treatment. Modeling heat transfer can allow the temperature of the surrounding air and the diameter of the tree to be inputs which will then result in outputs in the form of information on the time that can be required to heat the tree to the intended temperature. An example of the results given by a preliminary attempt to model heat transfer of a citrus tree heated with dry heated air as the source of supplemental heat is given in Table 1.1, which presents the time needed for the cambium region of trunk diameters of 3-6 inches heated with air at temperatures of about 113° F., about 122° F., about 131° F., or about 140° F. to reach about 107.6° F.

The tree conductivity and the air convection coefficient can influence the time and temperature combination. When using various supplemental heat sources, the values of the convection coefficient can be adjusted to reflect the property of the source. For instance, if using steam as the supplementary heat source, it is estimated that the air convection coefficient is higher, thus the time to reach a certain temperature would be faster. The values in the Table 1.1, hence, would be smaller if using steam as the source for supplementary heat.

TABLE 1.1

| Trunk | | Time for Cambium to Reach 107.6° F. (minutes) | | | |
|---|---|---|---|---|---|
| Diameter | | If T air = | If T air = | If T air = | If T air = |
| Inch | Cm | 113° F. | 122° F. | 130° F. | 140° F. |
| 3 | 7.62 | 197.0 | 105.0 | 70.5 | 51.5 |
| 4 | 10.16 | >240 | 137.5 | 89.5 | 64.0 |
| 5 | 12.7 | >240 | 167.5 | 106.0 | 74.0 |
| 6 | 15.24 | >240 | 195.0 | 120.0 | 83.5 |

Supplemental heat can be used rather than solar heat to provide uniformity and control. Uniformity means that the heat distribution throughout the canopy is uniform. Control means that there is more freedom in determining and maintaining the temperature surrounding the canopy. With this, weather variability becomes less of a problem compared to just using heat from the sun. Another benefit of using supplemental heat is that heat treatment is not limited to the summer and it is possible to extend the heat treatment to a longer period. Various sources of supplemental heat also provides different heating results. Examples of the differences in using supplemental radiant heat (A), supplemental dry heat (B), and supplemental heat from steam (C) on heating of citrus trees can be observed. Using radiant heaters to provide thermal treatment can require a longer treatment during as cloud cover greatly affects the temperature within the tent. So, weather still plays an important factor in the effectiveness of this type of treatment. Dry heat using a heat tunnel technique yielded similar results as the radiant heat. However, the time to heat the trees to the required temperature was greatly reduced. Cloud cover has little effect of the temperature within the tent which means weather variability has less impact than the radiant heat method. Supplemental heat from steam results can result in the fastest treatment. The temperature within the tent increases rapidly and weather variability has no noticeable effect.

Example Method of Treatment

Using a heating tunnel prototype that incorporates two radiant infrared heaters and four fans, thirty six trees were heated to three different temperatures. Within each treatment temperature, three different duration times were chosen. The nine combinations are: about 113° F. for about 60 min, about 113° F. for about 120 min, about 113° F. for about 180 min, about 122° F. for about 40 min, about 122° F. for about 80 min, about 122° F. for about 120 min, about 131° F. for about 20 min, about 131° F. for about 40 min, and about 131° F. for about 60 min. For each tree, about 10 to about 12 thermocouples were placed at various spots within the tree canopy as well as in the soil to monitor the uniformity of the temperature. Two additional trees were tested at about 140° F. for about 5 and about 10 min. These trees were included to evaluate the capacity at which a tree could withstand high temperatures and still recover within a relatively short period of time. A third radiant infrared heater was added and reflective panels were placed on the ground to aid in maintaining such a high temperature.

A heat transfer test was conducted to quantify the amount of heat the tree absorbs during each test and to measure the internal temperatures throughout the tree. Small holes were drilled at varying parts of the tree and thermocouples were placed inside. Surface temperature and air temperatures were also collected at these sites. The test was done using the same heat tunnel prototype with some minor adjustments. A third heater was added and reflective panels were placed on the ground to limit the heat absorbed by the soil. This test is the first step in developing a model to simulate heat transfer through the tree for each test.

Results of the heat transfer tests will be based on overall tree health, fruit production, and juice quality. To further quantify the results for overall tree health; physiological measurements were added to the study. These measurements include leaf porosity measurements, water potential measurements, leaf anatomy cross section, and chlorophyll fluorescence measurements. For each time-temperature combination, two trees were randomly selected for these tests. These samples are taken before treatment, 7 days after treatment, 1 month after treatment, 3 months after treatment, 6 months after treatment, 9 months after treatment, and 1 year after treatment. In addition, a multi-band aerial image was obtained using a small UAV over time to access the overall health of trees using different vegetation indices.

Results

Some preliminary conclusions can be extracted from the current data. Trees that were treated at about 122° F. have shown signs of improvement. The leaves have less blotchy mottle and the new growth had little to no visible symptoms. The trees exposed to about 131° F. also show signs of improvement based on color and new growth. However, the effects of the heat treatment caused more damage to these trees. The branches directly above the heaters were highly damaged and in most cased did not recover. For this reason, a treatment temperature of about 131° F. treatments have treated the tree with less damage to the tree.

As used herein, disjunctive language, such as the phrase “at least one of X, Y, or Z,” unless specifically stated otherwise, is otherwise understood with the context as used in general to present that an item, term, etc., can be either X, Y, or Z, or any combination thereof (e.g., X, Y, and/or Z). Thus, such disjunctive language does not imply that certain embodiments require at least one of X, at least one of Y, or at least one of Z to each be present.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. To further illustrate, a temperate range of “about 1° F. to about 5° F. should be interpreted to include not only the explicitly recited temperatures of about 1° F. to about 5° F., but also include individual temperatures (e.g., 2° F., 3° F., and 4° F.) and the sub-ranges (e.g., 0.5%, 1.2° F., 2.3° F., 3.4° F., and 4.4° F.) within the indicated range. In an embodiment, the term “about” can include traditional rounding according to significant figures of the numerical value. In addition, the phrase “about ‘x’ to ‘y’” includes “about ‘x’ to about ‘y’”.

It is understood that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

We claim at least the following:

1. A system, comprising:
a mobile housing defining a region that is at least partially enclosed, wherein the mobile housing is configured to be positioned so that a plant is disposed at least partially within the region;
a heating unit coupled to the mobile housing, the heating unit configured to provide heat to the; and
a temperature control unit configured to control a temperature within the region.

2. The system of claim 1, further comprising an air circulation unit configured to provide an airflow in the region.

3. The system of claim 1, wherein the heating unit is configured to heat a reservoir of water to generate steam having a temperature of about 120° F. to about 150° F., and the steam being released into the region.

4. The system of claim 1, wherein the mobile housing is adjustable so that at least one dimension of the region is adjustable.

5. The system of claim 1, wherein the mobile housing is configured to move to a plurality of plants so as to enclose at least two plants within the mobile housing during movement of the mobile housing.

6. The system of claim 1, wherein the heating unit is configured to provide the heat to the region for about five minutes to about ten minutes.

7. The system of claim 1, wherein the mobile housing is self-propelled.

8. The system of claim 1, wherein the mobile housing is configured to be moved by a vehicle.

9. The system of claim 1, wherein the mobile housing further comprises a humidifying unit configured to aid in controlling the temperature within the region.

10. The system of claim 1, wherein the heating unit comprises a medicinal unit configured to hold and release medicine into the region.

11. The system of claim 1, wherein the heating unit comprises a horticultural mineral oil unit configured to hold and release horticultural mineral oil into the region.

12. A method comprising:
enclosing and treating a plant by a mobile housing comprising a heating unit and a temperature control unit, the mobile housing defining a region that is at least partially enclosed, wherein the mobile housing is configured to be positioned so that the plant is disposed at least partially within the region; and maintaining a temperature within the region using the heating unit and the temperature control unit, wherein the temperature is a predetermined temperature that reduces rate of disease in the plant.

13. The method of claim 12, further comprising heating the plant within the mobile housing for a treatment duration, wherein the treatment duration is a predetermined period of time that the plant should be treated to reduce disease in the plant, and wherein the treatment duration is based on the temperature.

14. The method of claim 13, wherein the predetermined period of time is between about five minutes and about ten minutes, and wherein the heating unit is configured to generate and release steam having a temperature within the temperature.

15. The method of claim 14, further comprising at least one of an electric radiant heater or an additional infrared heater.

16. The method of claim 12, wherein the temperature control unit controls the heating unit and a circulation unit to maintain the temperature uniformly throughout the region.

17. The method of claim 12, wherein the mobile housing further comprises a steam unit configured to release a predetermined amount of steam to raise a temperature within the region.

18. The method of claim 12, wherein the temperature is about 120° F. to about 150° F.

19. The method of claim 12, wherein a treatment duration is about 5 minutes to about 120 minutes based on the temperature.

20. A system, comprising:
a mobile housing defining a region that is at least partially enclosed, wherein the mobile housing is configured to be positioned so that a plant is disposed at least partially within the region;
a heat source comprising a steam generator configured to generate steam having a temperature, the temperature being sufficient to reduce disease in the plant; and
a channel configured to transport the steam from the heat source to the region within the mobile housing.
